(19) United States
(12) Patent Application Publication
(10) Pub. No.: US 2010/0176708 A1
(43) Pub. Date: Jul. 15, 2010

(54) X-RAY EMITTING FOIL WITH TEMPORARY FIXING BARS AND PREPARING METHOD THEREFORE

(75) Inventor: Stefan Hauttmann, Buchholz (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/602,515

(22) PCT Filed: May 29, 2008
(86) PCT No.: PCT/IB08/52094

§ 371 Date: Dec. 1, 2009

(30) Foreign Application Priority Data
Jun. 1, 2007 (EP) 07109397.5

(51) Int. Cl. H01J 1/00; H01J 9/02

(52) U.S. Cl. 313/310; 445/51

(57) ABSTRACT

The invention describes an emitter device (10) and a method for precisely mounting a thin film electron emitter foil into a cathode cup. Therefore, small fixing bars (71) are realized to keep fine and hence weak emitter structures in position while fixing this setup onto a cathode cup. After mounting those temporary structures are removed (72) to get the final functional emitter-cathode setup.

### FIELD OF THE INVENTION

The present invention relates to the field of fast high-current electron sources for X-ray tubes. In particular, the present invention relates to an emitter device for X-ray tubes with a thin film electron emitter and a method to preparing such emitter before its application in an X-ray tube.

### ART BACKGROUND

The future demands for high-end CT and CV imaging regarding the X-ray source are higher power/tube current, shorter response-times regarding the tube current (pulse modulation) and smaller focal spots (FS) for higher image quality.

One key to reach higher power in smaller FS is given by using a sophisticated electron optical concept. But of same importance are the electron source itself and the starting condition of the electrons.

For today's high-end tubes directly heated thin flat emitters are used that are structured to define an electrical path and to obtain the required high electrical resistance. Basically, two different emitter designs comprising the explained features are well known: An emitter with a round or rectangular emitting surface/emitting section.

The first of the two types, for example explained in U.S. Pat. No. 6,426,587 B, is a thermionic emitter with balancing thermal conduction legs.

Generally, these types of emitters have a small thermal response time due to their small thickness from 100 μm up to a few hundred of micrometers and sufficient optical qualities owing to their flatness. Variations of such designs are implemented in today's state-of-the-art X-ray tubes.

Due to the thin foil and fine structures of the above-mentioned design it is mechanically weak. It is possible, that deformations within the emitter foils structure occur during the mounting process of the emitter foil onto the terminals that are fixed within a cathode cup. A slit widening with negative influence on the optical properties of the setup or in worst case, a short-circuit within the electrical path and hence a failure of the system could be the result. The current path changes drastically which leads to a failure of the system.

Therefore, it is an object of the invention to provide an emitter device which may avoid an deformation of the foil of the emitter device during the mounting process.

### SUMMARY OF THE INVENTION

This object is achieved in accordance with the invention with an emitter device comprising a foil at least with a part adapted to emit electrons and a removable fixing bar adapted to stabilize the position of the foil, wherein the fixing bar bridges a slit in the foil.

Thus, the foil is stabilized due to its structure during the mounting process by said fixing bars.

In one embodiment of the invention, the foil has a uniform thickness in a range between 50 μm and 300 μm, preferably, in a range between 100 μm and 200 μm, wherein the fixing bars are a solid part of the foil. According to another preferred variant of the invention, the foil consists of tungsten or a tungsten alloy.

Further, in another embodiment of the invention, a first end of the fixing bar is attached to a first border area of the electron emitting part of the foil, and a second end of the fixing bar is attached to a second border area of the electron emitting part of the foil, and wherein the first and second border areas are arranged parallel to each other.

According to another preferred embodiment of the invention, a first end of the fixing bar is attached to a first border area of the electron emitting part of the foil, and a second end of the fixing bar is attached to a second border area of a non-electron-emitting part of the foil, and wherein the first and second border areas are arranged parallel to each other.

According to an exemplary embodiment of the present invention, the foil is designed such, that the non-electron-emitting part surrounds at least partially the electron emitting part.

Furthermore, according to another exemplary embodiment of the present invention, the emitter device comprises a plurality of removable fixing bars each adapted to stabilize the position of the foil; wherein the fixing bars bridge at least one slit in the foil.

According to an exemplary embodiment of the present invention, the emitter device further comprises at least one terminal adapted to fix the foil.

According to an exemplary embodiment, the present invention relates to a cathode device that comprises the emitter device according to one of the said embodiments.

According to an exemplary embodiment, the present invention relates to an X-ray tube that comprises the emitter device according to one of the said embodiments.

The present invention relates in a further embodiment to a method for preparing an emitter device according to one of the said embodiments. The method comprises the steps of mounting the emitting device on at least one fixing device and removing the fixing bar of the foil.

According to an exemplary embodiment of the present invention, the fixing bar is removed by laser ablation.

According to an exemplary embodiment of the present invention, the fixing bar is removed by applying high currents to the bars to realize a burn through.

According to an exemplary embodiment of the present invention, the fixing bar is removed by sawing.

According to an exemplary embodiment of the present invention, the fixing bar is removed by eroding.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered to be disclosed with this application.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

These and other aspects of the present invention will become apparent from and elucidated with reference to the embodiments described hereinafter.

### BRIEF DESCRIPTION OF THE INVENTION

Exemplary embodiments of the present invention will be described in the following, with reference to the following drawings.

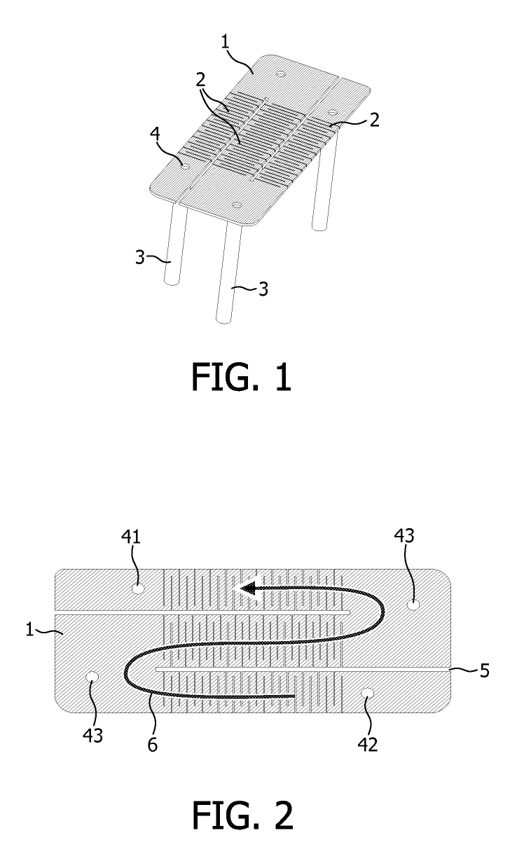

FIG. 1 shows a common directly heated first emitter device with a rectangular central emitting part.

FIG. 2 shows the foil of the emitting device according to FIG. 1, but in a top view.

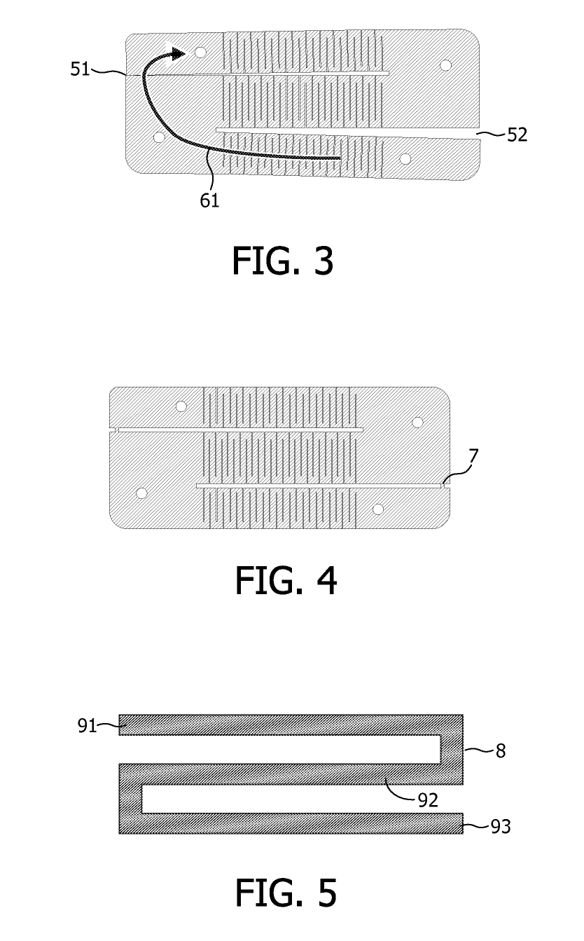

FIG. 3 shows the foil of the emitting device according to FIG. 1 in a top view with deformed slits.

FIG. 4 shows a second foil of a emitter device with two fixing bars.

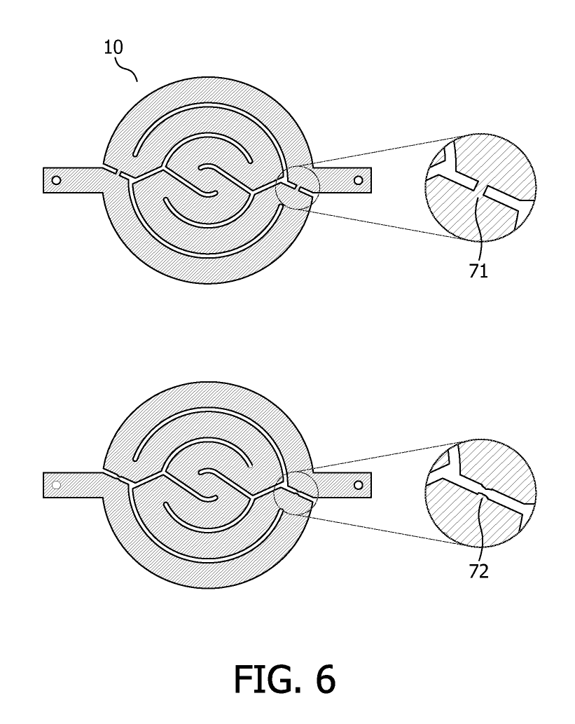

FIG. 5 shows a principal mechanical setup of the foil design of the FIGS. 1 to 4.

FIG. 6 shows a third foil and a cut of it in top view one before and one after removing two fixing bars.

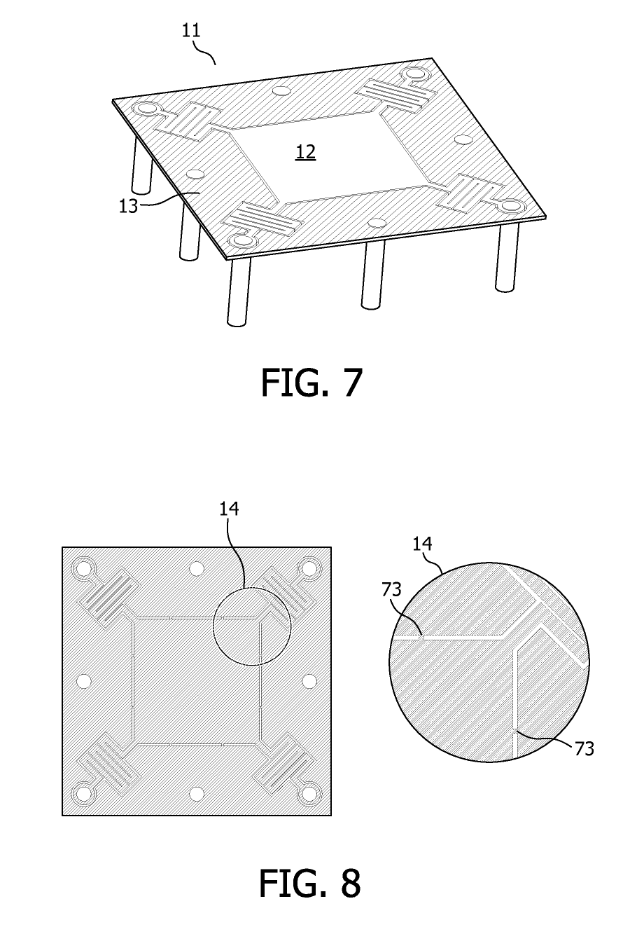

FIG. 7 shows an emitting device with a fourth foil and a surrounding frame after mounting and removing the fixing bars.

FIG. 8 shows the complete foil with eight fixing bars and a cut out of it before preparing.

### DETAILED DESCRIPTION

FIG. 1 shows a directly heated thin flat emitter foil 1 with a rectangular emitting surface formed by a fine structured central part which is adapted to emit electrons. The said part defines an electrical path and the required high electrical resistance to release sufficient Joule heat. This foil 1 is fixed onto terminals 3 e.g. by welding in points 4. Further, the foil 1 is divided into three meander sections 2 to increase mechanical stability against external forces like the centrifugal force on a gantry within a CT-system.

FIG. 2 shows the foil more detailed. The emitter sections 2 are separated by slits 5. Further, the first terminal fixed in point 41 is connected to ground potential, the second terminal fixed in point 42 to a positive potential with respect to ground potential. The two terminals to the other fixing points 43 are electrically floating. Hence, an electrical current flows from point 42 to point 41 via the electrical path 6 symbolized by the black arrow.

FIG. 3 shows the foil of the emitting device according to FIG. 1 in a top view with a widening slit 52. Due to the thin foil and fine structures of the above-mentioned design it is mechanically weak. It is possible, that deformations within the emitter foil structure occur during the mounting process of the emitter foil onto the terminals that are fixed within a cathode cup. The shown slit widening 52 has negative influence on the optical properties of the setup or in worst case, a short-circuit 51 within the electrical path 61 (black arrow). Hence, a failure of the system could be the result. The current path 61 changes drastically which leads to a failure of the system.

The invention avoids the above-mentioned failure due to an emitter foil deformation during the mounting process.

FIG. 4 shows a second foil of an emitter device with two fixing bars. The above-mentioned problem of a foil deformation during the mounting process is overcome by adding fixing bars 7 that bridges critical slits. In this respect the term “critical slit” means that these slits may deform significantly under external forces, which could lead to reduced optical properties of the setup or to a complete failure of the emitter.

FIG. 5 shows a principal mechanical setup of the foil design of the FIGS. 1 to 4. The principle mechanical setup 8 in FIG. 5 of the emitter design exemplarily illustrates the term “critical slit”. The setup 8 is predominantly determined by three long lever bars 91 to 93 which influence the slits 51, 52 in FIG. 2. External forces, e.g. during the mounting process, are amplified and focused to the base of the slit, which lead to high stress levels. Large displacements could result at the end of the levers due to their length (theorem on intersecting lines). Their mechanical behavior is eliminated by adding the fixing bars not shown here.

The principle idea of adding fixing bars could be applied to every structured emitter foil comprising slits and lever bars, e.g. a circular shaped flat emitter with two terminals 10 as shown in FIG. 6. Here, the two temporarily added fixing bars 71 transform the geometry to a stable structure where no displacements within the slits could occur. Removing the bars 72 after mounting leads to the desired functionality of the emitter. The bars could be cut e.g. by laser ablation to mechanically and thermally separate the structures.

A critical slit could also be a slit between an electron emitting area of the foil and a non-electron-emitting frame of the foil where a precise positioning is essential to maintain the functionality. Exemplarly, another emitter design 11 with an indirect heated emitter having the latter critical slit situation is shown in FIG. 7. Due to its complex design, it is very difficult to precisely mount the electron emitting part 12 and the surrounding non-electron-emitting frame 13 without getting in contact. Implementing the narrow fixing bars 73 in detail 14 as shown in FIG. 8 between both parts of the foil solves this problem.

Thus, an emitter device and a method for precisely mounting a thin film electron emitter foil into a cathode cup is described. Therefore, small fixing bars are realized to keep fine and hence weak emitter structures in position while fixing this setup onto a cathode cup. After mounting those temporary structures are removed to get the final functional emitter-cathode setup.

It should be noted that the term “comprising” does not exclude other elements or steps and the “a” or “an” does not exclude a plurality. Further, it should be noted, that any reference signs in the claims shall not be construed as limiting the scope of the claims.

1. An emitter device comprising:
a foil at least with a part adapted to emit electrons;
a removable fixing bar adapted to stabilize the position of the foil;
wherein the fixing bar bridges a slit in the foil.

2. The emitter device according to claim 1, wherein a first end of the fixing bar is attached to a first border area of the electron emitting part of the foil, and a second end of the fixing bar is attached to a second border area of the electron emitting part of the foil, and wherein the first and second border areas are arranged parallel to each other.

3. The emitter device according to claim 1, wherein a first end of the fixing bar is attached to a first border area of the electron emitting part of the foil, and a second end of the fixing bar is attached to a second border area of a non-electron-emitting part of the foil, and wherein the first and second border areas are arranged parallel to each other.

3. The emitter device according to claim 3, wherein the foil is designed such, that the non-electron-emitting part surrounds at least partially the electron emitting part.

4. The emitter device according to claim 1 wherein the emitter device comprises a plurality of removable fixing bars each adapted to stabilize the position of the foil; wherein the fixing bars bridge at least one slit in the foil.

5. The emitter device according to claim 1 further comprising:
at least one terminal adapted to fix the foil.

6. A cathode device, comprising the emitter device according to claim 1.

7. An X-ray tube comprising the emitter device according to claim 1.

8. A method for preparing an emitter device according to claim 1, comprising the steps:
mounting the emitting device on at least one fixing device;
removing the fixing bar of the foil.

9. The method of claim 5, wherein the fixing bar is removed by laser ablation.

10. The method of claim 5, wherein the fixing bar is removed by applying high currents to the bars to realize a burn through.

11. The method of claim 5, wherein the fixing bar is removed by sawing.

12. The method of claim 5, wherein the fixing bar is removed by eroding.
